(19) United States
(12) Patent Application Publication
(10) Pub. No.: US 2020/0161726 A1
(43) Pub. Date: May 21, 2020

(54) PORTABLE ELECTRONIC APPARATUS AND BATTERY TEMPERATURE CONTROL METHOD THEREOF

(71) Applicant: Wistron Corporation, New Taipei City (TW)

(72) Inventors: Chen-Yi Liang, New Taipei City (TW); Yung-Chen Chang, New Taipei City (TW); Wei-Lun Lin, New Taipei City (TW)

(73) Assignee: Wistron Corporation, New Taipei City (TW)

(21) Appl. No.: 16/290,962

(22) Filed: Mar. 4, 2019

(30) Foreign Application Priority Data
Nov. 20, 2018 (TW) 107141157

(51) Int. Cl. H01M 10/637; H01M 10/48; H01M 10/6572; H01M 10/623

(52) U.S. Cl. CPC H01M 10/637; H01M 10/486; H01M 2220/30; H01M 10/6572; H01M 10/623; H01M 10/488

(57) ABSTRACT

A portable electronic apparatus and a battery temperature control method thereof are provided. The portable electronic apparatus includes a battery module and a temperature adjustment module. The temperature adjustment module is coupled to the battery module and configured to obtain a temperature value of the battery module from the battery module. The temperature adjustment module heats or cools the battery module according to the temperature value of the battery module to control the temperature of the battery module.

### CROSS-REFERENCE TO RELATED APPLICATION

This application claims the priority benefit of Taiwan application serial no. 107141157, filed on Nov. 20, 2018. The entirety of the above-mentioned patent application is hereby incorporated by reference herein and made a part of this specification.

### BACKGROUND

### Technical Field

The invention relates to a battery technique of an electronic apparatus, and particularly relates to a portable electronic apparatus with a battery temperature adjusting mechanism and a battery temperature control method thereof.

### Description of Related Art

Regarding portable electronic apparatuses, power resources thereof are generally rechargeable batteries, for example, lithium-ion batteries. The lithium-ion batteries are rechargeable batteries that generate energy through electrochemical reactions. Generally, the rechargeable batteries such as the lithium-ion batteries all have recommended operating temperatures, for example, 0° C. to 45° C. When a temperature of the lithium-ion battery is higher than or lower than the recommended operating temperature, not only charging or discharging of the lithium-ion battery may be failed to influence the operation of the portable electronic apparatus, but also the lithium-ion battery may be aged or has a thermal collapse.

### SUMMARY

The invention is directed to a portable electronic apparatus and a battery temperature control method thereof, which are adapted to heat or cool a battery module of the portable electronic apparatus to control a temperature of the battery module.

The invention provides a portable electronic apparatus including a battery module and a temperature adjustment module. The temperature adjustment module is coupled to the battery module, and is configured to obtain a temperature value of the battery module from the battery module. The temperature adjustment module heats or cools the battery module according to the temperature value of the battery module to control a temperature of the battery module.

In an embodiment of the embodiment, when the temperature value of the battery module is lower than a first temperature value, the temperature adjustment module heats the battery module.

In an embodiment of the embodiment, when the temperature value of the battery module is higher than a second temperature value, the temperature adjustment module cools the battery module, where the second temperature value is higher than the first temperature value.

The invention provides a portable electronic apparatus including a battery module and a temperature adjustment module. The temperature adjustment module includes a control module and a thermoelectric element. The control module is coupled to the battery module, and is configured to obtain a temperature value of the battery module from the battery module, and generate a control voltage according to the temperature value of the battery module. The thermoelectric element is coupled to the control module to receive the control voltage, and is disposed on the battery module. The thermoelectric element heats or cools the battery module in response to the control voltage.

The invention provides a battery temperature control method adapted to control a temperature of a battery module of a portable electronic apparatus. The battery temperature control method includes following steps: obtaining a temperature value of the battery module from the battery module by a temperature adjustment module of the portable electronic apparatus; and heating or cooling the battery module by the temperature adjustment module according to the temperature value of the battery module.

According to the above description, in the portable electronic apparatus and the battery temperature control method thereof, the battery module is heated or cooled according to the temperature value of the battery module, so as to control the temperature of the battery module. In this way, charging efficiency and discharging efficiency of the battery module is enhanced and a service life of the battery module is prolonged. Besides, by controlling the temperature of the battery module, the temperature inside the portable electronic apparatus is prevented from being too high, thereby improving an overall performance of the portable electronic apparatus.

To make the aforementioned more comprehensible, several embodiments accompanied with drawings are described in detail as follows.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a circuit block schematic diagram of a portable electronic apparatus according to an embodiment of the invention.

FIG. 2 is a circuit block schematic diagram of a temperature adjustment module according to an embodiment of the invention.

FIG. 3 is a schematic diagram of an internal framework of a thermoelectric element and a configuration of the thermoelectric element and a battery module according to an embodiment of the invention.

FIG. 4 is a circuit block schematic diagram of a control module according to an embodiment of the invention.

FIG. 5 is a circuit block schematic diagram of a portable electronic apparatus according to another embodiment of the invention.

FIG. 6 is a flowchart illustrating a battery temperature control method according to an embodiment of the invention.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

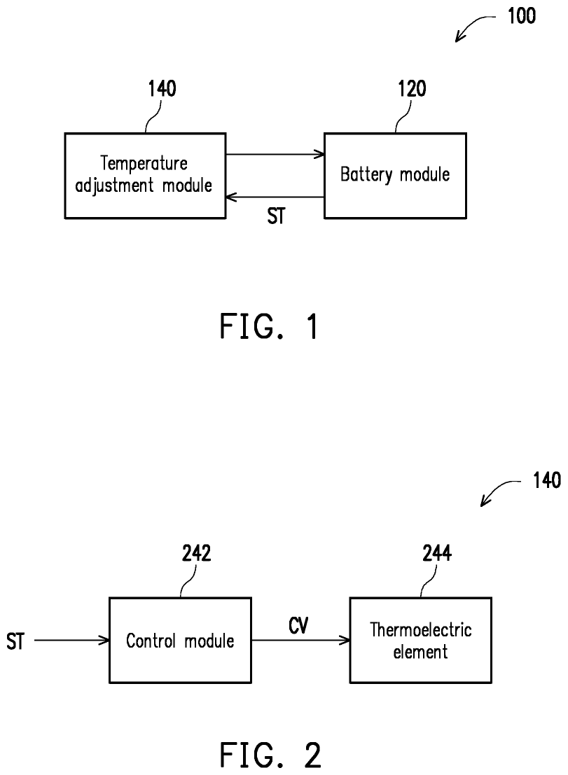

Referring to FIG. 1, FIG. 1 is a circuit block schematic diagram of a portable electronic apparatus 100 according to an embodiment of the invention. In an embodiment of the invention, the portable electronic apparatus 100 is, for example, a notebook computer, a tablet computer or a smart phone, etc., though the invention is not limited thereto. The portable electronic apparatus 100 includes a battery module 120 and a temperature adjustment module 140. The battery module 120 is used for providing electrical energy required for a main body of the portable electronic apparatus 100 to function properly. The temperature adjustment module 140 is coupled to the battery module 120. The temperature adjustment module 140 is configured to obtain a temperature value ST of the battery module 120 from the battery module 120. The temperature adjustment module 140 may heat or cool the battery module 120 according to the temperature value ST of the battery module 120 to control a temperature of the battery module 120. In this way, the temperature of the battery module 120 may be maintained to a specific temperature range, so as to improve charging discharging efficiency of the battery module 120 and prolong a service life of the battery module 120. Besides, by controlling the temperature of the battery module 120, the temperature inside the portable electronic apparatus 100 is prevented from being too high, thereby improving an overall performance of the portable electronic apparatus 100.

In an embodiment of the invention, the battery module 120 is, for example, a module containing one or a plurality of batteries (or battery elements). Besides, the battery module 120 may be a rechargeable battery module such as a nickel-zinc battery, a nickel-hydrogen battery, a nickel-cadmium battery, a lead-acid battery, a lithium-ion battery, a lithium polymer battery or a lithium iron phosphate battery, though the invention is not limited thereto.

In an embodiment of the invention, a temperature sensor and a register may be built in the battery module 120. The temperature sensor may sense the temperature of the battery module 120, and store the sensed temperature value ST of the battery module 120 in the aforementioned register. Moreover, the aforementioned register may also store various states of the battery module 120.

In an embodiment of the invention, the temperature adjustment module 140 may determine whether the temperature value ST of the battery module 120 is lower than a first temperature value. When the temperature value ST of the battery module 120 is lower than the first temperature value, the temperature adjustment module 140 may heat the battery module 120 to prevent the temperature of the battery module 120 from being too low to cause aging or even failure in charging and discharging.

In an embodiment of the invention, the temperature adjustment module 140 may determine whether the temperature value ST of the battery module 120 is higher than a second temperature value. When the temperature value ST of the battery module 120 is higher than the second temperature value, the temperature adjustment module 140 may cool the battery module 120 to prevent the temperature of the battery module 120 from being too high to cause aging or even failure in charging and discharging, where the second temperature value is higher than the first temperature value, and the first temperature value and the second temperature value may be set according to battery characteristics of the battery module 120.

In an embodiment of the invention, when the temperature value ST of the battery module 120 is higher than the first temperature value and lower than the second temperature value, the temperature adjustment module 140 stops adjusting the temperature of the battery module 120.

In an embodiment of the invention, the temperature adjustment module 140 may further obtain a state of the battery module 120 from the battery module 120, and heats or cools the battery module 120 according to the obtained temperature value ST and the state of the battery module 120.

In an embodiment of the invention, when the temperature value ST of the battery module 120 is lower than the first temperature value and the state of the battery module 120 is a charging state or a discharging state, the temperature adjustment module 140 may heat the battery module 120 to prevent the temperature of the battery module 120 from being too low to cause failure in charging or discharging.

In an embodiment of the invention, when the temperature value ST of the battery module 120 is higher than the second temperature value and the state of the battery module 120 is the charging state, the temperature adjustment module 140 may cool the battery module 120 to prevent the temperature of the battery module 120 from being too high to cause failure in charging.

In an embodiment of the invention, when the temperature value ST of the battery module 120 is higher than a third temperature value and the state of the battery module 120 is the discharging state, the temperature adjustment module 140 may cool the battery module 120 to prevent the temperature of the battery module 120 from being too high to cause failure in discharging, where the third temperature value is higher than the second temperature value.

Referring to FIG. 1 and FIG. 2 together, FIG. 2 is a circuit block schematic diagram of the temperature adjustment module 140 according to an embodiment of the invention. The temperature adjustment module 140 may include a control module 242 and a thermoelectric element 244. The control module 242 is coupled to the battery module 120 of FIG. 1, and is configured to obtain the temperature value ST of the battery module 120 from the battery module 120, and generate a control voltage CV according to the temperature value ST of the battery module 120. Alternatively, the control module 242 may obtain the temperature value ST and the state of the battery module 120 from the battery module 120, and heats or cools the battery module 120 according to the obtained temperature value ST and the state of the battery module 120. The thermoelectric element 244 is disposed on the battery module 120. Besides, the thermoelectric element 244 is coupled to the control module 242 to receive the control voltage CV, and the thermoelectric element 244 may heat or cool the battery module 120 in response to the control voltage CV.

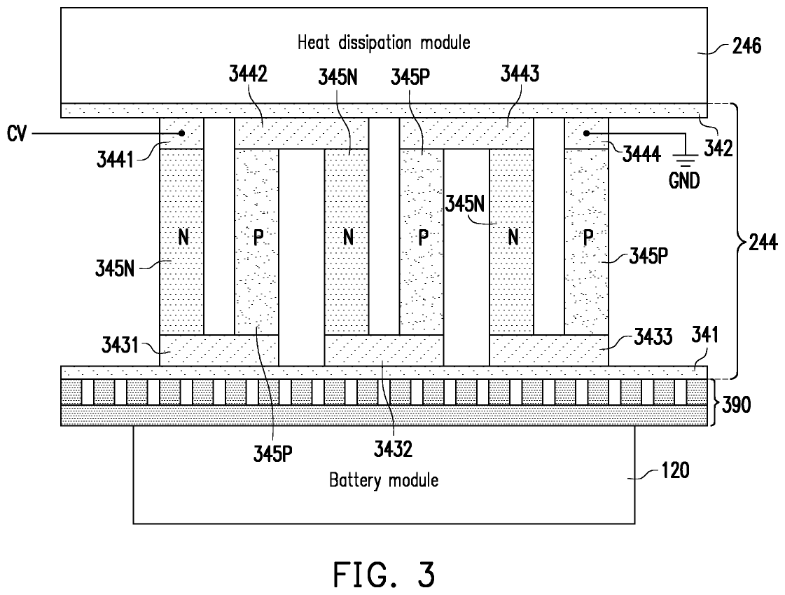

Referring to FIG. 2 and FIG. 3, FIG. 3 is a schematic diagram of an internal framework of the thermoelectric element 244 and a configuration of the thermoelectric element 244 and the battery module 120 according to an embodiment of the invention. As shown in FIG. 3, the thermoelectric element 244 includes a first substrate 341, a second substrate 342, a plurality of first conductive layers 3431-3433, a plurality of second conductive layers 3441-3444, a plurality of P-type semiconductor pins 345P and a plurality of N-type semiconductor pins 345N. In the embodiment of FIG. 3, the first substrate 341 of the thermoelectric element 244 is thermally coupled to the battery module 120 through a thermal spreader 390, though the invention is not limited thereto. In other embodiments of the invention, the first substrate 341 of the thermoelectric element 244 may be directly thermally coupled to the battery module 120.

The first conductive layers 3431-3433 are disposed on the first substrate 341. The second conductive layers 3441-3444 are disposed on the second substrate 342. The P-type semiconductor pins 345P and the N-type semiconductor pins 345N are arranged in interleaving, and the P-type semiconductor pins 345P and the N-type semiconductor pins 345N are sequentially and electrically connected through the first conductive layers 3431-3433 and the second conductive layers 3441-3444. The P-type semiconductor pins 345P and the N-type semiconductor pins 345N are coupled to the first substrate 341 through the first conductive layers 3431-3433, and coupled to the second substrate 342 through the second conductive layers 3441-3444.

The second conductive layer 3441 of the thermoelectric element 244 receives the control voltage CV, and the second conductive layer 3444 of the thermoelectric element 244 is coupled to a ground voltage GND. The thermoelectric element 244 is controlled by the control voltage CV, as a result, one of two sides (i.e. the first substrate 341 and the second substrate 342) of the thermoelectric element 244 is a heating side, and the other one of the two sides (i.e. the first substrate 341 and the second substrate 342) of the thermoelectric element 244 is a cooling side.

In detail, if the control voltage CV provided by the control module 242 is a negative voltage, a current flows from the P-type semiconductor pin 345P to the N-type semiconductor pin 345N through the first conductive layer 3431 (3432, 3433), which increases a temperature of the first conductive layer 3431 (3432, 3433), so that the first substrate 341 becomes the heating side and is adapted to heat the battery module 120. Moreover, the current flows from the N-type semiconductor pin 345N to the P-type semiconductor pin 345P through the second conductive layer 3442 (3443), which decreases a temperature of the second conductive layer 3442 (3443), so that the second substrate 342 becomes the cooling side.

Comparatively, if the control voltage CV provided by the control module 242 is a positive voltage, the current flows from the N-type semiconductor pin 345N to the P-type semiconductor pin 345P through the first conductive layer 3431 (3432, 3433), which decreases the temperature of the first conductive layer 3431 (3432, 3433), so that the first substrate 341 becomes the cooling side and is adapted to cool the battery module 120. Moreover, the current flows from the P-type semiconductor pin 345P to the N-type semiconductor pin 345N through the second conductive layer 3442 (3443), which increases the temperature of the second conductive layer 3442 (3443), so that the second substrate 342 becomes the heating side.

In an embodiment of the invention, the temperature adjustment module 140 may further include a heat dissipation module 246, where the heat dissipation module 246 is thermally coupled to the second substrate 342 of the thermoelectric element 244. When the second substrate 342 is the heating side, the heat dissipation module 246 may be used for decreasing the temperature of the second substrate 342. In an embodiment of the invention. The heat dissipation module 246 may include a heat sink, a fan or a combination thereof, though the invention is not limited thereto.

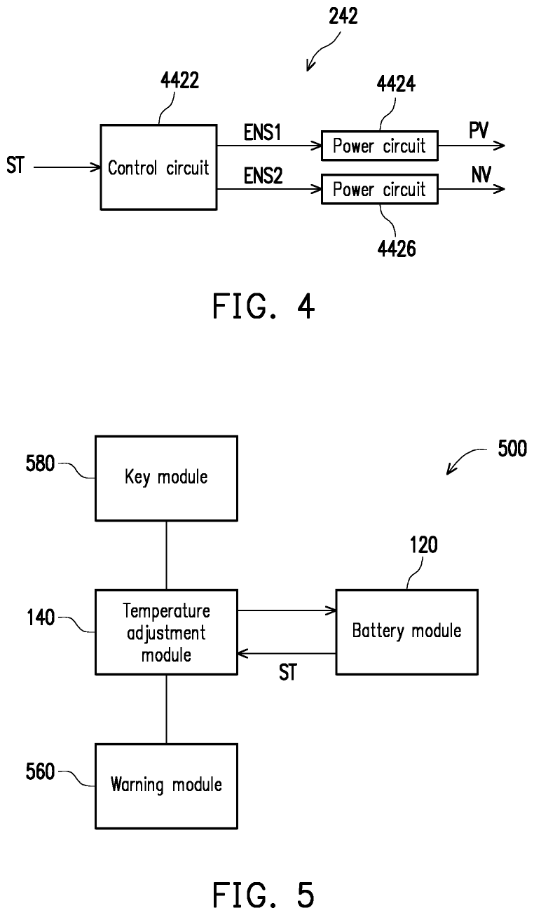

Referring to FIG. 3 and FIG. 4, FIG. 4 is a circuit block schematic diagram of the control module 242 according to an embodiment of the invention. The control module 242 may include a control circuit 4422 and power circuits 4424 and 4426. The control circuit 4422 serves as an operation core of the control module 242. The control circuit 4422 may obtain the temperature value ST of the battery module 120 from the battery module 120, and generate control signals ENS1 and ENS2 according to the temperature value ST of the battery module 120. The power circuits 4424 and 4426 are coupled to the control circuit 4422 to respectively receive the control signals ENS1 and ENS2. The power circuit 4424 may be enabled in response to the control signal ENS1 at a first level, and generates a positive voltage PV to serve as the control voltage CV, so that the thermoelectric element 244 cools the battery module 120. Moreover, the power circuit 4424 may be disabled in response to the control signal ENS1 at a second level to stop outputting the positive voltage PV, where the first level and the second level are different voltage levels. Similarly, the power circuit 4426 may be enabled in response to the control signal ENS2 at the first level, and generates a negative voltage NV to serve as the control voltage CV, so that the thermoelectric element 244 heats the battery module 120. Moreover, the power circuit 4426 may be disabled in response to the control signal ENS2 at the second level to stop outputting the negative voltage NV.

For example, if the temperature value ST of the battery module 120 is lower than the first temperature value, the control circuit 4422 may generate the control signal ENS1 at the second level to disable the power circuit 4424, and generate the control signal ENS2 at the first level to enable the power circuit 4426. In this way, the power circuit 4426 generates the negative voltage NV to serve as the control voltage CV, so that the thermoelectric element 244 heats the battery module 120. Enough instructions and descriptions for other operation details of the control circuit 4422 and the power circuits 4424 and 4426 may be learned and deduced from the description of the embodiments of FIG. 1 and FIG. 2, and details thereof are not repeated.

In an embodiment of the invention, the control circuit 4422 is, for example, a programmable general purpose or special purpose microprocessor, a programmable controller, an Application Specific Integrated Circuit (ASIC) or other similar device or a combination of the above devices, though the invention is not limited thereto.

In an embodiment of the invention, the power circuits 4424 and 4426 may be implemented by voltage regulators, though the invention is not limited thereto.

Referring to FIG. 5, FIG. 5 is a circuit block schematic diagram of a portable electronic apparatus 500 according to another embodiment of the invention. The portable electronic apparatus 500 includes the battery module 120, the temperature adjustment module 140, a warning module 560 and a key module 580. Implementation and operation details of the battery module 120 and the temperature adjustment module 140 of FIG. 5 are respectively similar to that of the battery module 120 and the temperature adjustment module 140 of FIG. 1, so that descriptions thereof may refer to related descriptions of FIG. 1 to FIG. 4, which are not repeated. Implementation and operations of the warning module 560 and the key module 580 are described below.

The warning module 560 is coupled to the temperature adjustment module 140. When the temperature value of the battery module 120 is lower than the first temperature value or higher than the second temperature value, it represents that the temperature of the battery module 120 is abnormal (too high or too low), and the temperature adjustment module 140 controls the warning module 560 to generate a warning message to warn the user.

The key module 580 is coupled to the temperature adjustment module 140. The key module 580 has a key. The key module 580 may activate the temperature adjustment module 140 in response to pressing of the key. In this way, the user may determine whether to activate a battery temperature adjustment function of the portable electronic apparatus 500 by himself. For example, the user may preset the battery temperature adjustment function of the portable electronic apparatus 500 to be off. The user may press the key to activate the temperature adjustment module 140 after the warning module 560 sends the warning message, such that the temperature adjustment module 140 may heat or cool the battery module 120 according to the temperature value ST of the battery module 120.

In an embodiment, the portable electronic apparatus 500 may include a function setting application (not shown). The user may use the portable electronic apparatus 500 to execute the function setting application, such that a screen of the portable electronic apparatus 500 displays a User Interface (UI) of the function setting application. The UI of the function setting application may include a disable/enable option of the temperature adjustment module 140. The portable electronic apparatus 500 may correspondingly disable or enable the temperature adjustment module 140 based on the disable/enable option of the temperature adjustment module 140 on the UI. In this way, the user may enable or disable the battery temperature adjustment function of the portable electronic apparatus 500 by clicking the enable/disable option of the temperature adjustment module 140.

In an embodiment of the invention, the warning module 560 is, for example, a charging status indicator of the portable electronic apparatus 500, where the charging status indicator may be implemented by a Light Emitting Diode (LED). When the temperature adjustment module 140 determines that the temperature of the battery module 120 is abnormal, the temperature adjustment module 140 may control the LED to flick to achieve a warning effect.

In another embodiment of the invention, when the temperature adjustment module 140 determines that the temperature of the battery module 120 is abnormal, the temperature adjustment module 140 may display temperature abnormal information on the screen of the portable electronic apparatus 500 to achieve the warning effect.

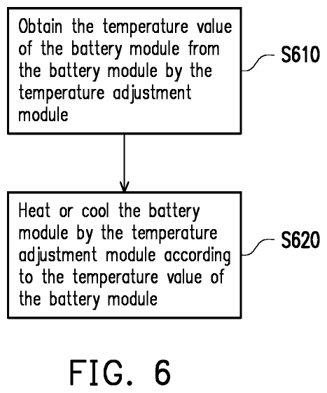

FIG. 6 is a flowchart illustrating a battery temperature control method according to an embodiment of the invention, and the battery temperature control method may be applied to the portable electronic apparatus 100 shown in FIG. 1 (or the portable electronic apparatus 500 shown in FIG. 5), though the invention is not limited thereto. Referring to FIG. 1 and FIG. 6, the battery temperature control method includes a step S610 and a step S620. In the step S610, the temperature adjustment module 140 obtains the temperature value ST of the battery module 120 from the battery module 120. Then, in the step S620, the temperature adjustment module 140 heats or cools the battery module 120 according to the temperature value ST of the battery module 120 to control the temperature of the battery module 120.

Moreover, enough instructions and recommendations for details of the battery temperature control method of the invention may be learned from related descriptions of the embodiments of FIG. 1 to FIG. 5, and details thereof are not repeated.

In summary, in the portable electronic apparatus and the battery temperature control method thereof of the embodiments of the invention, the battery module is heated or cooled according to the temperature value of the battery module, so as to control the temperature of the battery module. In this way, the temperature of the battery module may be maintained to a specific temperature range, so as to improve charging discharging efficiency of the battery module and prolong a service life of the battery module. Besides, by controlling the temperature of the battery module, the temperature inside the portable electronic apparatus is prevented from being too high, thereby improving an overall performance of the portable electronic apparatus.

It will be apparent to those skilled in the art that various modifications and variations can be made to the disclosed embodiments without departing from the scope or spirit of the invention. In view of the foregoing, it is intended that the invention covers modifications and variations provided they fall within the scope of the following claims and their equivalents.

What is claimed is:

1. A portable electronic apparatus, comprising:
a battery module; and
a temperature adjustment module, coupled to the battery module, configured to obtain a temperature value of the battery module from the battery module, and heating or cooling the battery module according to the temperature value of the battery module, so as to control a temperature of the battery module.

2. The portable electronic apparatus as claimed in claim 1, wherein when the temperature value of the battery module is lower than a first temperature value, the temperature adjustment module heats the battery module.

3. The portable electronic apparatus as claimed in claim 2, wherein when the temperature value of the battery module is higher than a second temperature value, the temperature adjustment module cools the battery module, wherein the second temperature value is higher than the first temperature value.

4. The portable electronic apparatus as claimed in claim 3, wherein when the temperature value of the battery module is higher than the first temperature value and lower than the second temperature value, the temperature adjustment module stops adjusting the temperature of the battery module.

5. The portable electronic apparatus as claimed in claim 3, further comprising:
a warning module, coupled to the temperature adjustment module, wherein when the temperature value of the battery module is lower than the first temperature value or higher than the second temperature value, the temperature adjustment module controls the warning module to generate a warning message.

6. The portable electronic apparatus as claimed in claim 1, wherein the temperature adjustment module further obtains a state of the battery module from the battery module, and heats or cools the battery module according to the temperature value and the state of the battery module.

7. The portable electronic apparatus as claimed in claim 6, wherein when the temperature value of the battery module is lower than the first temperature value and the state of the battery module is a charging state or a discharging state, the temperature adjustment module heats the battery module.

8. The portable electronic apparatus as claimed in claim 7, wherein
when the temperature value of the battery module is higher than a second temperature value and the state of the battery module is the charging state, the temperature adjustment module cools the battery module, wherein the second temperature value is higher than the first temperature value; and
when the temperature value of the battery module is higher than a third temperature value and the state of the battery module is the discharging state, the temperature adjustment module cools the battery module, wherein the third temperature value is higher than the second temperature value.

9. The portable electronic apparatus as claimed in claim 1, further comprising:
a key module, coupled to the temperature adjustment module, wherein the key module has a key, and the key module activates the temperature adjustment module in response to pressing of the key.

10. A portable electronic apparatus, comprising:
a battery module; and
a temperature adjustment module, comprising:
a control module, coupled to the battery module, and configured to obtain a temperature value of the battery module from the battery module, and generating a control voltage according to the temperature value of the battery module; and
a thermoelectric element, coupled to the control module to receive the control voltage, and disposed on the battery module, wherein the thermoelectric element heats or cools the battery module in response to the control voltage.

11. The portable electronic apparatus as claimed in claim 10, wherein the temperature adjustment module further comprises a heat dissipation module, wherein two sides of the thermoelectric element are respectively thermally coupled to the battery module and the heat dissipation module, and the thermoelectric element is controlled by the control voltage, such that one of the two sides of the thermoelectric element is a heating side, and another one of the two sides of the thermoelectric element is a cooling side.

12. A battery temperature control method, adapted to control a temperature of a battery module of a portable electronic apparatus, the battery temperature control method comprising:
obtaining a temperature value of the battery module from the battery module by a temperature adjustment module of the portable electronic apparatus; and
heating or cooling the battery module by the temperature adjustment module according to the temperature value of the battery module.

13. The battery temperature control method as claimed in claim 12, wherein the step of heating or cooling the battery module by the temperature adjustment module according to the temperature value of the battery module comprises:
heating the battery module when the temperature value of the battery module is lower than a first temperature value.

14. The battery temperature control method as claimed in claim 13, wherein the step of heating or cooling the battery module by the temperature adjustment module according to the temperature value of the battery module further comprises:
cooling the battery module when the temperature value is higher than a second temperature value, wherein the second temperature value is higher than the first temperature value.

15. The battery temperature control method as claimed in claim 14, wherein the step of heating or cooling the battery module by the temperature adjustment module according to the temperature value of the battery module further comprises:
stopping adjusting the temperature of the battery module when the temperature value of the battery module is higher than the first temperature value and lower than the second temperature value.

16. The battery temperature control method as claimed in claim 14, further comprising:
sending a warning message by a warning module of the portable electronic apparatus when the temperature value of the battery module is lower than the first temperature value or higher than the second temperature value.

17. The battery temperature control method as claimed in claim 12, wherein the step of heating or cooling the battery module by the temperature adjustment module according to the temperature value of the battery module further comprises:
obtaining a state of the battery module from the battery module by the temperature adjustment module; and
heating or cooling the battery module by the temperature adjustment module according to the temperature value and the state of the battery module.

18. The battery temperature control method as claimed in claim 17, wherein the step of heating or cooling the battery module by the temperature adjustment module according to the temperature value and the state of the battery module comprises:
heating the battery module by the temperature adjustment module when the temperature value of the battery module is lower than the first temperature value and the state of the battery module is a charging state or a discharging state.

19. The battery temperature control method as claimed in claim 18, wherein the step of heating or cooling the battery module by the temperature adjustment module according to the temperature value and the state of the battery module further comprises:
cooling the battery module by the temperature adjustment module when the temperature value of the battery module is higher than a second temperature value and the state of the battery module is the charging state, wherein the second temperature value is higher than the first temperature value; and
cooling the battery module by the temperature adjustment module when the temperature value of the battery module is higher than a third temperature value and the state of the battery module is the discharging state, wherein the third temperature value is higher than the second temperature value.

20. The battery temperature control method as claimed in claim 12, further comprising:
activating the temperature adjustment module by a key module of the portable electronic apparatus in response to pressing of a key of the key module.
